(19) United States
(12) Patent Application Publication
(10) Pub. No.: US 2020/0193511 A1
(43) Pub. Date: Jun. 18, 2020

(54) UTILIZING EMBEDDINGS FOR EFFICIENT MATCHING OF ENTITIES

(71) Applicant: SAP SE, Walldorf (DE)

(72) Inventors: Sean Saito, Singapore (SG); Chaitanya Krishna Joshi, Singapore (SG); Rajalingappaa Shanmugamani, Singapore (SG); Truc Viet Le, Singapore (SG); Rajesh Vellore Arumugam, Singapore (SG)

(21) Appl. No.: 16/217,148

(22) Filed: Dec. 12, 2018

(51) Int. Cl. G06Q 40/02; G06N 3/08

(52) U.S. Cl. CPC G06Q 40/02; G06N 3/08

(57) ABSTRACT

Methods, systems, and computer-readable storage media for receiving, by a machine learning (ML) platform, a set of invoices including two or more invoices, processing, by the ML platform, each invoice through a neural network to provide respective invoice embeddings, each invoice embedding including a multi-dimensional vector, comparing, by the ML platform, invoice embeddings to define two or more super-invoices, each super-invoice including a sub-set of the set of invoices, and matching a bank statement to a super-invoice of the two or more super-invoices.

### BACKGROUND

In general, machine learning includes training a machine learning (ML) model that receives input, and provides some output. Machine learning can be used in a variety of problem spaces. An example problem space includes matching items of one entity to items of another entity. Examples include, without limitation, matching questions to answers, people to products, and bank statements to invoices. In many situations, it is required to match an item from one entity to a set of items from another. For example, it is possible for a customer to clear multiple invoices with a single payment, which can be referred to as a multi-match (many-to-one), as opposed to a single-match (one-to-one).

In some instances, non-overlapping sub-sets of items are formed, and a sub-set can be matched to the single item. Traditionally, pairwise matching of items can be performed to create sub-sets. However, the time complexity of such approaches is quadratic, and not scalable to large data sizes under realistic hardware and resource constraints.

### SUMMARY

Implementations of the present disclosure are directed to matching a single items to a sub-set of items of a set of items. More particularly, implementations of the present disclosure are directed to utilizing embeddings of items for creating sub-sets of items from a set of items, and matching a single item to a sub-set of items.

In some implementations, actions include receiving, by a machine learning (ML) platform, a set of invoices including two or more invoices, processing, by the ML platform, each invoice through a neural network to provide respective invoice embeddings, each invoice embedding including a multi-dimensional vector, comparing, by the ML platform, invoice embeddings to define two or more super-invoices, each super-invoice including a sub-set of the set of invoices, and matching a bank statement to a super-invoice of the two or more super-invoices. Other implementations of this aspect include corresponding systems, apparatus, and computer programs, configured to perform the actions of the methods, encoded on computer storage devices.

These and other implementations can each optionally include one or more of the following features: prior to processing an invoice through the neural network, characters in fields of the invoice are concatenated to define a string of characters that is processed through the neural network; the neural network includes a convolution neural network including multiple convolution layers, and respective activation layers; three convolution layers are provided, a first convolution layer having 128 filters, a second convolution layer having 128 filters, and a third convolution layer having 32 filters; the neural network includes an output layer that reduces a higher-dimensional vector output to provide the multi-dimensional vector; comparing invoice embeddings to define two or more super-invoices comprises determining a distance between pairs of invoice embeddings, and comparing the distance to a threshold distance; and the distance includes one of a Euclidean distance and a cosine distance.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIGS. 2A and 2B depict an example of emergence of meaningful spatial relationships in an invoice embedding space.

FIG. 3 depicts an example conceptual architecture in accordance with implementations of the present disclosure.

FIG. 4 depicts an example process that can be executed in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to matching a single items to a sub-set of items of a set of items. More particularly, implementations of the present disclosure are directed to utilizing embeddings of items for creating sub-sets of items from a set of items, and matching a single item to a sub-set of items. Implementations can include actions of receiving, by a machine learning (ML) platform, a set of invoices including two or more invoices, processing, by the ML platform, each invoice through a neural network to provide respective invoice embeddings, each invoice embedding including a multi-dimensional vector, comparing, by the ML platform, invoice embeddings to define two or more super-invoices, each super-invoice including a sub-set of the set of invoices, and matching a bank statement to a super-invoice of the two or more super-invoices.

Implementations of the present disclosure are described in further detail with reference to an example problem space that includes matching bank statements to invoices. More particularly, implementations of the present disclosure are described with reference to the problem of, given one bank statement (e.g., a computer-readable electronic document recording data representative of the bank statement), determining a set of invoices that the bank statement matches to (e.g., each invoice being a computer-readable electronic document recording data representative of the invoice). It is contemplated, however, that implementations of the present disclosure can be realized in any appropriate problem space.

As described in further detail herein, the ML platform of the present disclosure enables optimized creation of sub-sets of invoices, referred to herein as super-invoices from a set of invoices. A bank statement can then be matched to a super-invoice of the multiple super-invoices. Implementations of the present disclosure use a neural network that projects invoices to an embedding space, which enables a significant reduction in the number of pairwise operations performed to form the super-invoices. This reduction in asymptotic time complexity is a crucial benefit, which enables the ML platform for matching bank statements to invoices to be deployed in a production landscape under realistic hardware and resource constraints.

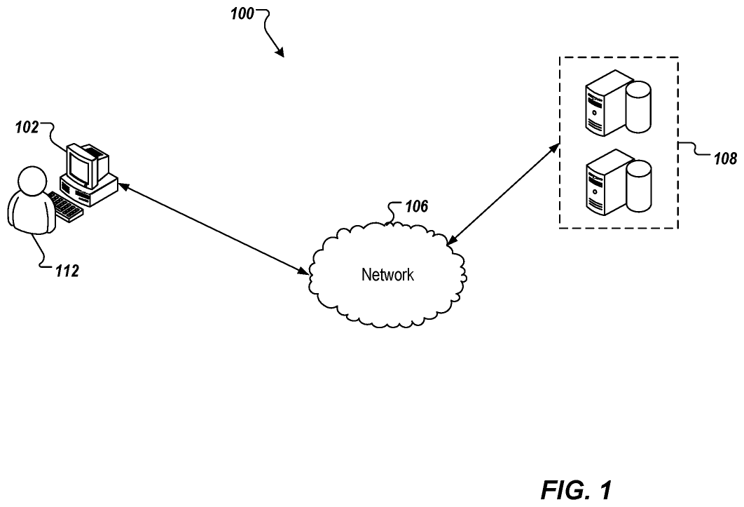

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a machine learning-based (ML-based) platform for multi-matching of electronic documents. That is, the server system 104 can receive computer-readable electronic documents (e.g., bank statements, invoices), and can match a single electronic document (e.g., a bank statement) to a set of electronic documents (e.g., a set of invoices).

As introduced above, implementations of the present disclosure are directed to ML platform for matching items from one entity to those of another entity. In particular, implementations of the present disclosure are directed to the domain of matching bank statements to invoices, where one payment can be issued to clear a set of invoices. Matching a single bank statement to multiple invoices is referred to herein as multi-matches).

Implementations of the present disclosure address computational complexity that arises from attempting to form non-overlapping sub-sets of invoices from a set of invoices, each sub-set of invoices being referring to as a super-invoice. For example, n invoices are provided, and the matching probability of every invoice pair is to be computed, which has a complexity of O(n²). In some examples, it can be assumed that the number of invoices n is considerably larger than the average size of super-invoices (e.g., a super-invoice can include 2 to 4 invoices). Consequently, most of the pairwise computations are redundant, as most invoice pair matching probabilities are negligibly small.

In view of this context, implementations of the present disclosure address this scalability problem using deep learning. As described in further detail herein, the ML platform of the present disclosure uses neural networks for semantic representation to formulate an efficient solution with linear time complexity.

For further context, advances in applying deep neural networks to natural language processing (NLP) problems are based on representing entities (from concepts or sentences to words or letters) as a fixed-size vector of numbers, called embeddings. Intuitively, embeddings enable abstract, relative representations of information associated with the entities that help deep learning models “understand” the data they are given.

In accordance with implementations of the present disclosure, each invoice is represented as a high-dimensional vector that is obtained using a neural network. These vectors, referred to as invoice embeddings, can encode the semantic meaning of the fields in an invoice, and can be used to for the identification of super-invoices (i.e., sub-sets of the n invoices). In some examples, a vector can be described herein with reference to a tabular format including rows, and columns, where each column corresponds to a respective dimension. In some examples, a multi-dimensional vector can correspond to multiple rows, and multiple columns. In some examples, a multi-dimensional vector can correspond to a single row, and multiple columns. In some examples, a multi-dimensional vector corresponding to multiple rows can be flattened to a multi-dimensional vector corresponding to a single row.

In some implementations, an invoice embedding is provided for an invoice by passing the invoice (e.g., an electronic document including data representative of an invoice) through a parameterized function referred to as an embedder. In some examples, a set of features corresponding to the invoice are provided as inputs to the embedder, and the embedder outputs a vector of d numbers (d-dimensions). Neural networks provide powerful embedder functionality due to their ability to represent non-linear relationships between inputs and outputs, and their tendency to learn general patterns in data without any feature engineering.

In some implementations, super-invoices can be thought of as shared identities between invoices, where all invoices belonging to the same super-invoice have the same identity. The neural network embedder can be optimized to produce embeddings from invoices of the same super-invoice set to be closer to each other than to embeddings from invoices of different super-invoice sets with respect to a distance metric. Example distance metrics can include, without limitation, Euclidean distance, and cosine distance.

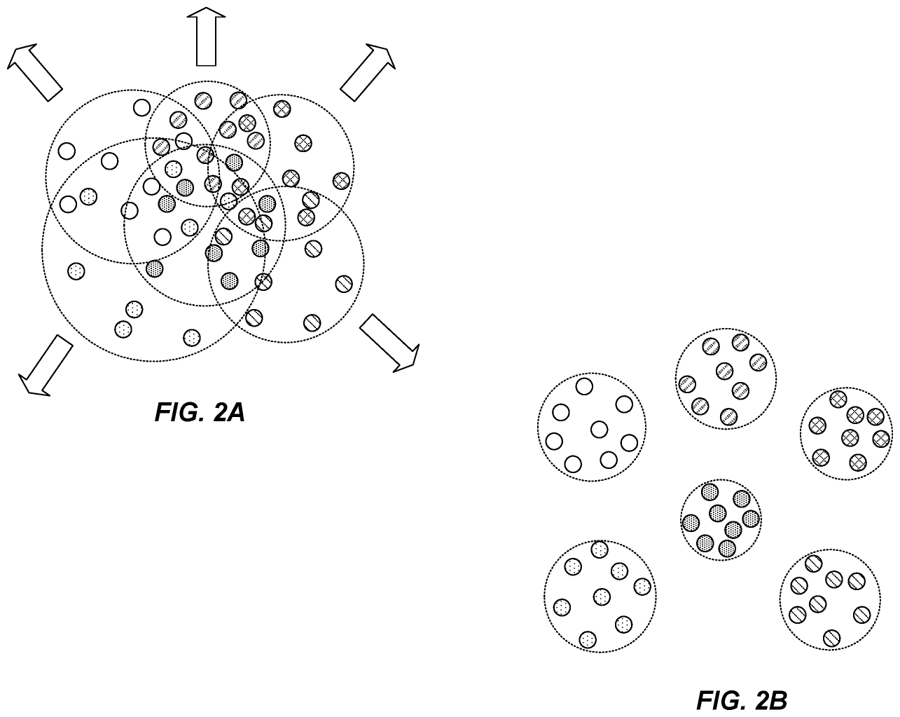

FIGS. 2A and 2B depict an example of emergence of meaningful spatial relationships in an invoice embedding space. In some implementations, as the ML model (neural network) is trained, it is seen that spatial or angular relationships between invoices in the embedding space start representing distinguishable clusters of super-invoices (e.g., the transition from FIG. 2A to FIG. 2B).

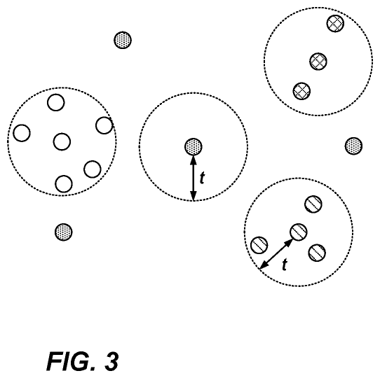

FIG. 3 depicts example formation of super-invoices in accordance with implementations of the present disclosure. In some implementations, and as described in further detail herein, a super-invoice is assigned to a set of invoice embeddings, they are all within a fixed threshold distance t of each-other in the embedding space. That is, they are each-other's nearest neighbors separated by a distance that does not exceed the threshold distance t.

In some implementations, and with regard to the neural network architecture, a key consideration when designing an embedder function for invoices is that it is able to model complex, non-linear interactions between various fields of the invoice, and produce a fixed-length vector encapsulating these fields. In some implementations, a convolutional neural network (CNN) architecture is implemented for building the invoice embeddings. In general, CNNs can be thought of as pattern matchers, which can be trained to learn multiple “filters” which produce “activations” to specific patterns in inputs (e.g., sequences of text). Each filter may correspond to the presence or absence of certain patterns, and fusing their responses together by adding more layers of filters on top of the first can model higher level interactions between these patterns. The output of such operations, called convolutions, is a fixed-size vector representing the input's semantic information.

In accordance with implementations of the present disclosure, for each invoice, input features to the CNN are provided by concatenating all of the characters (e.g., letters, numbers, symbols) in various field values together as a string. In some examples, each field is separated from the other fields by a ‘|’ character. In some examples, one or more strings are padded with blank symbols, such that all input features have the same length. The following attributes of invoices are non-limiting example attributes that can be concatenated to create the input string: Memo Line, Fiscal Year, Posting Date, Amount, Company Code, Organization Names, City, Partner Company Name, Debtor Name, Country, Transaction Currency, Financial Account Type, Accounting Document Type, Accounting Document Item, and Accounting Document Header Text.

In some implementations, each character in the string is converted into a character embedding using an embedding lookup matrix. In this manner, the string of attributes is represented as a sequence of character embeddings. The sequence of character embedding undergoes multiple layers of convolution operations with multiple filters followed by the application of a non-linear activation function to produce an activation map. In some examples, the activation map is flattened into a one-dimensional vector, and is passed through a single, densely connected layer of d neurons with linear activations to obtain the final d-dimensional embedding vector.

As a filter is convolved over the input string, activations are produced in response to certain fields. For example, some filters may learn to represent dates and years, whereas other filters may model relationships between companies and their debtors. As more convolution layers are stacked, filters that fuse interactions between downstream filters may emerge. Accordingly, a deep CNN can be trained to find highly complex patterns in invoice fields compared to any naïve pattern matcher based on hand-crafted rules.

An example stack of convolution is described in further detail herein. It is contemplated, however, that any appropriate stack of convolutions layers, and respective configurations can be used to realize implementations of the present disclosure. The example stack includes three convolution layers with a rectified linear unit (ReLU) activation function as non-linearity, and a fixed filter size of five (5) is set for all filters. In the example stack, the number of filters of the layers is 128, 128 and 32, respectively. In some examples, the fixed input string length is 200 characters, the size of each character embedding is 64, and the output embedding dimension d is 128.

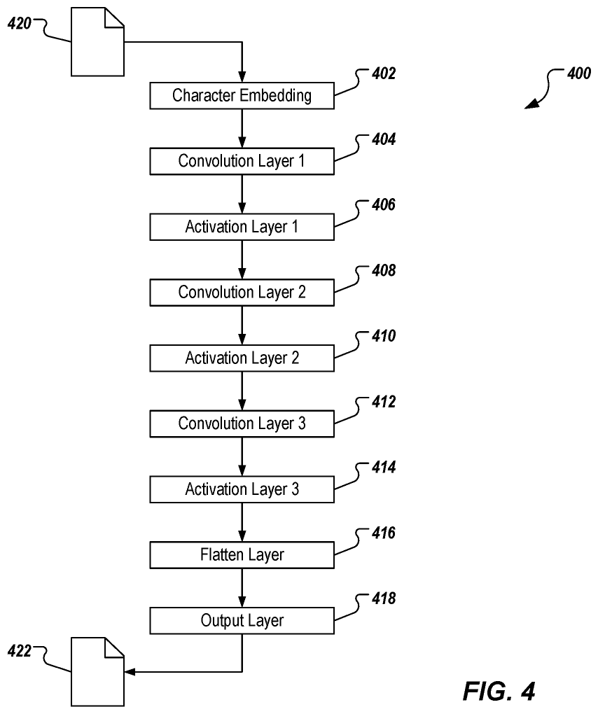

FIG. 4 depicts an example conceptual architecture 400 in accordance with implementations of the present disclosure. The example conceptual architecture 400 provides the detailed architecture of the example stack, including the intermediate layer sizes. In the depicted example, the example conceptual architecture includes a character embedding 402, a first convolution layer 404, a first activation layer 406, a second convolution layer 408, a second activation layer 410, a third convolution layer 412, a third activation layer 414, a flatten layer 416, and an output layer 418. An input 420, which includes concatenated field values of an invoice (e.g., a 200 character string) is processed through the layers to provide an output 422, which includes a d-dimensional vector. The layers 404, 406, 408, 410, 412, 414, 416, 418 collectively define a CNN. In some examples, the CNN is trained in a Siamese Network manner, using a Contrastive Loss Function for the Euclidean distance between embeddings, and a margin equal to 20.

In some examples, the character embedding 402 uses an embedding lookup to convert each character in the input 420 to a 64-dimensional vector, which is input to the first convolution layer 404. The first convolution layer 404 performs a single dimension (1D) dilated convolution using 128 filters of a width of 5, and a dilation factor of 1. The output of each of the filters is provided to the first activation layer 406, which applies a ReLU function to each filter output. The second convolution layer 408 performs a single dimension (1D) dilated convolution using 128 filters of a width of 5, and a dilation factor of 2. The output of each of the filters is provided to the second activation layer 410, which applies a ReLU function to each filter output. The third convolution layer 412 performs a single dimension (1D) dilated convolution using 32 filters of a width of 5, and a dilation factor of 4. The output of each of the filters is provided to the third activation layer 414, which applies a ReLU function to each filter output to provide a multi-dimensional output. In terms of a table, the multi-dimensional output corresponds to multiple rows (e.g., two rows), and multiple columns (e.g., a 5504-dimensional vector corresponding to 5504 columns).

The flatten layer 416 converts the output of the third activation layer 414 into a flattened, multi-dimensional vector. In terms of a table, the flattened multi-dimensional output corresponds to a single row, and multiple columns (e.g., a 5504-dimensional vector corresponding to 5504 columns). The output layer 418 is provided as a fully-connected layer that reduces the 5504-dimensional vector output from the flatten layer 416 to the 128-dimensional vector that is provided as the output 422. In terms of a table, the 128-dimensional vector corresponds to a single row, and 128 columns.

The output 422 represents a vector of a single invoice. accordingly, respective outputs 422 are provided for each invoice in a set of n invoices, from which super-invoices (sub-sets of invoices) are provided. As described herein, a pairwise comparison of vectors can be performed, which includes determining a distance between vectors in a vector pair (e.g., Euclidean distance, cosine distance). If the distance does not exceed the threshold distance t, the vectors in the pair of vectors are included in the same super-invoice (sub-set).

In some implementations, a bank statement can be matched to a super-invoice of the multiple super-invoices provided from the set of invoices. Matching of a bank statement to a super-invoice is described in commonly assigned U.S. application Ser. No. 16/208,681, filed on Dec. 4, 2018, and entitled Representing Sets of Entities for Matching Problems, the disclosure of which is expressly incorporated herein by reference in the entirety for all purposes.

Using embeddings to build super-invoices can be thought of as a faster, more scalable alternative to the pairwise matching approach, where a matching probability of every invoice pair is computed using a binary match/no-match classifier. Super-invoices can be formed from all matched invoice sets using rule-based heuristics or graphical approaches. The time complexity of such an approach is of the order O(n²), where n is the number of invoices to be grouped. However, quadratic time solutions are not scalable to large data sizes under realistic hardware and resource constraints. For example, 10,000 invoices would mean roughly 50 million pairwise computations.

Comparatively, the embedding approach of the present disclosure has a time complexity that only depends on the time taken by the embedding space to obtain an embedding's nearest neighbors. Fast approximate nearest neighbor finding algorithms can perform this operation in constant time, making the time complexity of the embedding approach of the present disclosure linear (i.e. in the order O(n)).

In accordance with implementations of the present disclosure, the embedding space is used to provide sub-sets of all invoices, and drastically reduce the number of pairwise operations to be performed. For each invoice, the pairwise matching probability is performed with only the k nearest neighboring invoices in the embedding space, as opposed to performing the operation for all possible invoice pairs. The number of the neighbors to query can be reduced by setting a pruning threshold based on the distance between the embedding and its neighbors. Here, matching probabilities are not computed when the distance between the embedding and the neighbor is greater than the pruning threshold.

If the embedding space provides good separation between the super-invoices, each invoice undergoes a pairwise matching operation with all other members of its super-invoice (as their embeddings should be close to the invoice's embedding), while performing exponentially fewer operations with non-matching invoices (e.g., at most k operations). By using the embedding space to create smart sub-sets (super-invoices), the time complexity of the pairwise matching approach is reduced from the quadratic O(n²) to the linear O(k*n), where k is an integer corresponding to the number of nearest neighbors considered in the embedding space, and n is the number of invoices to be grouped.

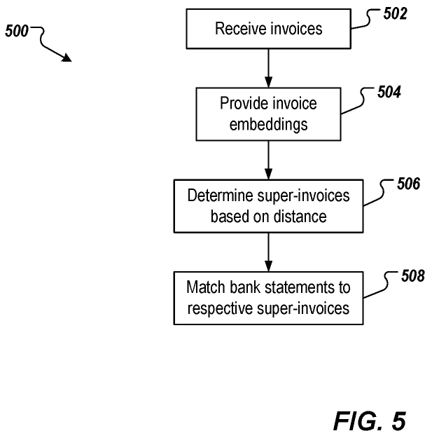

FIG. 5 depicts an example process 500 that can be executed in accordance with implementations of the present disclosure. In some examples, the example process 500 is provided using one or more computer-executable programs executed by one or more computing devices.

A set of invoices is received (502). For example, the ML platform of the present disclosure receives a set of invoices, each invoice being represented in an electronic document. Invoice embeddings are provided (504). For example, each invoice (e.g., data representative of the invoice) is processed through a CNN as described herein (e.g., with reference to FIG. 4) to provide an invoice embedding. The invoice embedding is provided as a d-dimensional vector (e.g., 128-dimensional vector). Super-invoices are determined based on distance between embeddings (506). For example, pairs of invoice embedding vectors are compared by determining a distance therebetween (e.g., Euclidean distance, cosine distance), and comparing the distance to a threshold distance t. If the distance does not exceed the threshold distance t, the invoices in the pair are included in the same super-invoice. If the distance exceeds the threshold distance t, the invoices in the pair are not included in the same super-invoice. Bank statements are matched to super-invoices (508). For example, each bank statement in a set of bank statements is compared to one or more super-invoices to determine whether the bank statement matches a single super-invoice.

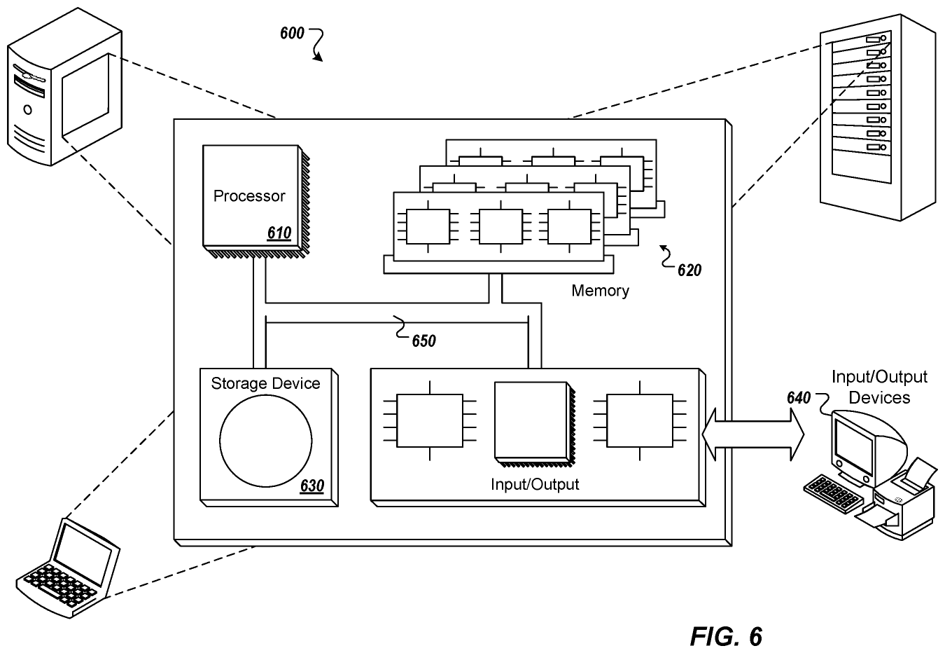

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing super-invoices from a set of invoices for matching to bank statements, the method being executed by one or more processors and comprising:
receiving, by a machine learning (ML) platform, a set of invoices comprising two or more invoices;
processing, by the ML platform, each invoice through a neural network to provide respective invoice embeddings, each invoice embedding comprising a multi-dimensional vector;
comparing, by the ML platform, invoice embeddings to define two or more super-invoices, each super-invoice comprising a sub-set of the set of invoices; and
matching a bank statement to a super-invoice of the two or more super-invoices.

2. The method of claim 1, wherein, prior to processing an invoice through the neural network, characters in fields of the invoice are concatenated to define a string of characters that is processed through the neural network.

3. The method of claim 1, wherein the neural network comprises a convolution neural network comprising multiple convolution layers, and respective activation layers.

4. The method of claim 3, wherein three convolution layers are provided, a first convolution layer having 128 filters, a second convolution layer having 128 filters, and a third convolution layer having 32 filters.

5. The method of claim 1, wherein the neural network comprises an output layer that reduces a higher-dimensional vector output to provide the multi-dimensional vector.

6. The method of claim 1, wherein comparing invoice embeddings to define two or more super-invoices comprises determining a distance between pairs of invoice embeddings, and comparing the distance to a threshold distance.

7. The method of claim 6, wherein the distance comprises one of a Euclidean distance and a cosine distance.

8. A non-transitory computer-readable storage medium coupled to one or more processors and having instructions stored thereon which, when executed by the one or more processors, cause the one or more processors to perform operations for providing super-invoices from a set of invoices for matching to bank statements, the operations comprising:
receiving, by a machine learning (ML) platform, a set of invoices comprising two or more invoices;
processing, by the ML platform, each invoice through a neural network to provide respective invoice embeddings, each invoice embedding comprising a multi-dimensional vector;
comparing, by the ML platform, invoice embeddings to define two or more super-invoices, each super-invoice comprising a sub-set of the set of invoices; and
matching a bank statement to a super-invoice of the two or more super-invoices.

9. The computer-readable storage medium of claim 8, wherein, prior to processing an invoice through the neural network, characters in fields of the invoice are concatenated to define a string of characters that is processed through the neural network.

10. The computer-readable storage medium of claim 8, wherein the neural network comprises a convolution neural network comprising multiple convolution layers, and respective activation layers.

11. The computer-readable storage medium of claim 10, wherein three convolution layers are provided, a first convolution layer having 128 filters, a second convolution layer having 128 filters, and a third convolution layer having 32 filters.

12. The computer-readable storage medium of claim 8, wherein the neural network comprises an output layer that reduces a higher-dimensional vector output to provide the multi-dimensional vector.

13. The computer-readable storage medium of claim 8, wherein comparing invoice embeddings to define two or more super-invoices comprises determining a distance between pairs of invoice embeddings, and comparing the distance to a threshold distance.

14. The computer-readable storage medium of claim 13, wherein the distance comprises one of a Euclidean distance and a cosine distance.

15. A system, comprising:
a computing device; and
a computer-readable storage device coupled to the computing device and having instructions stored thereon which, when executed by the computing device, cause the computing device to perform operations for providing super-invoices from a set of invoices for matching to bank statements, the operations comprising:
receiving, by a machine learning (ML) platform, a set of invoices comprising two or more invoices;
processing, by the ML platform, each invoice through a neural network to provide respective invoice embeddings, each invoice embedding comprising a multi-dimensional vector;
comparing, by the ML platform, invoice embeddings to define two or more super-invoices, each super-invoice comprising a sub-set of the set of invoices; and
matching a bank statement to a super-invoice of the two or more super-invoices.

16. The system of claim 15, wherein, prior to processing an invoice through the neural network, characters in fields of the invoice are concatenated to define a string of characters that is processed through the neural network.

17. The system of claim 15, wherein the neural network comprises a convolution neural network comprising multiple convolution layers, and respective activation layers.

18. The system of claim 17, wherein three convolution layers are provided, a first convolution layer having 128 filters, a second convolution layer having 128 filters, and a third convolution layer having 32 filters.

19. The system of claim 15, wherein the neural network comprises an output layer that reduces a higher-dimensional vector output to provide the multi-dimensional vector.

20. The system of claim 15, wherein comparing invoice embeddings to define two or more super-invoices comprises determining a distance between pairs of invoice embeddings, and comparing the distance to a threshold distance.
